(19) United States
(12) Patent Application Publication
(10) Pub. No.: US 2016/0161102 A1
(43) Pub. Date: Jun. 9, 2016

(54) LED Bulb

(71) Applicants: Ming-Shi Chou, Taichung City (TW); Ching-Hsiang Tseng, Taichung City (TW)

(72) Inventors: Ming-Shi Chou, Taichung City (TW); Ching-Hsiang Tseng, Taichung City (TW)

(21) Appl. No.: 14/558,756

(22) Filed: Dec. 3, 2014

(51) Int. Cl. F21V 29/77; F21V 29/503; F21V 23/00; F21S 2/00; F21K 99/00; F21V 23/04

(52) U.S. Cl. CPC F21V 29/773; F21K 9/135; F21V 23/04; F21V 23/005; F21S 2/005; F21V 29/503; F21Y 2101/02

(57) ABSTRACT

An LED bulb contains: a first shell, a second shell, a heat dissipating element fixed between the first shell and the second shell. The dissipating element includes a first substrate and a second substrate which correspond to the first shell and the second shell, wherein the first substrate includes at least one first LED lighting element, and the second substrate includes at least one second LED lighting element, such that lights illuminate out of the second shell and the first shell via a plurality of heat dissipation fins, thus having omnidirectional illumination. The at least one first LED lighting element of the first substrate illuminates the lights at 180 degrees. Preferably, the second shell is a sphere-shaped shell, a semi-arcuate shell or a flat shell to satisfy different using requirements.

### FIELD OF THE INVENTION

The present invention relates to an LED bulb which is modularized and contains a drive electrically isolated from a heat dissipating element to prolong a service life of the LED bulb.

### BACKGROUND OF THE INVENTION

A conventional LED bulb is applied to illuminate lights indoors or outdoors, but it has defects as follows:

1. An illuminating angle of the conventional LED bulb is less than that of a conventional bulb (such as an incandescent light bulb or an energy-saving bulb).

2. The conventional LED bulb cannot be used at a high temperature for a long time.

3. The conventional LED bulb has poor waterproof function.

4. The conventional LED bulb is produced at a large size because of a heat dissipating element of a large size.

5. The conventional LED bulb is produced at a high cost.

6. The conventional LED bulb contains a drive mounted therein, yet a heat of the drive cannot be dissipated effectively.

7. After the conventional LED bulb is broken, it cannot be recycled and reused.

The present invention has arisen to mitigate and/or obviate the afore-described disadvantages.

### SUMMARY OF THE INVENTION

The primary object of the present invention is to provide an LED bulb which is modularized and contains a drive electrically isolated from a heat dissipating element to prolong a service life of the LED bulb.

To obtain above object, an LED bulb provided by the present invention contains: a first shell, a second shell, a heat dissipating element fixed between the first shell and the second shell; the dissipating element includes a first substrate and a second substrate which correspond to the first shell and the second shell, wherein the first substrate includes at least one first LED lighting element, and the second substrate includes at least one second LED lighting element, such that lights illuminate out of the second shell and the first shell via a plurality of heat dissipation fins, thus having omnidirectional illumination.

The at least one first LED lighting element of the first substrate illuminates the lights at 180 degrees. Preferably, the second shell is a sphere-shaped shell, a semi-arcuate shell or a flat shell to satisfy different using requirements.

In addition, when the first substrate, the second substrate, the drive, the at least one first LED lighting element, or the at least one second LED lighting element is broken, any one of them is replaced easily to avoid discarding the LED bulb completely.

### BRIEF DESCRIPTION OF THE DRAWINGS

FIG. 1 is a perspective view showing an assembly of an LED bulb according to a first embodiment of the present invention.

FIG. 2 is a perspective view showing the exploded components of the LED bulb according to the first embodiment of the present invention.

FIG. 3 is a cross sectional view showing the assembly of the LED bulb according to the first embodiment of the present invention.

FIG. 4 is a cross sectional view showing the operation of the LED bulb according to the first embodiment of the present invention.

FIG. 5 is a perspective view showing the assembly of the LED bulb according to a second embodiment of the present invention.

FIG. 6 is a perspective view showing the exploded components of the LED bulb according to the second embodiment of the present invention.

FIG. 7 is a cross sectional view showing the assembly of the LED bulb according to the second embodiment of the present invention.

FIG. 8 is a cross sectional view showing the operation of the LED bulb according to the second embodiment of the present invention.

FIG. 9 is a perspective view showing the exploded components of the LED bulb according to a third embodiment of the present invention.

FIG. 10 is a cross sectional view showing the operation of the LED bulb according to the third embodiment of the present invention.

FIG. 11 is a cross sectional view showing the application of the LED bulb according to the second embodiment of the present invention.

### DETAILED DESCRIPTION OF THE PREFERRED EMBODIMENTS

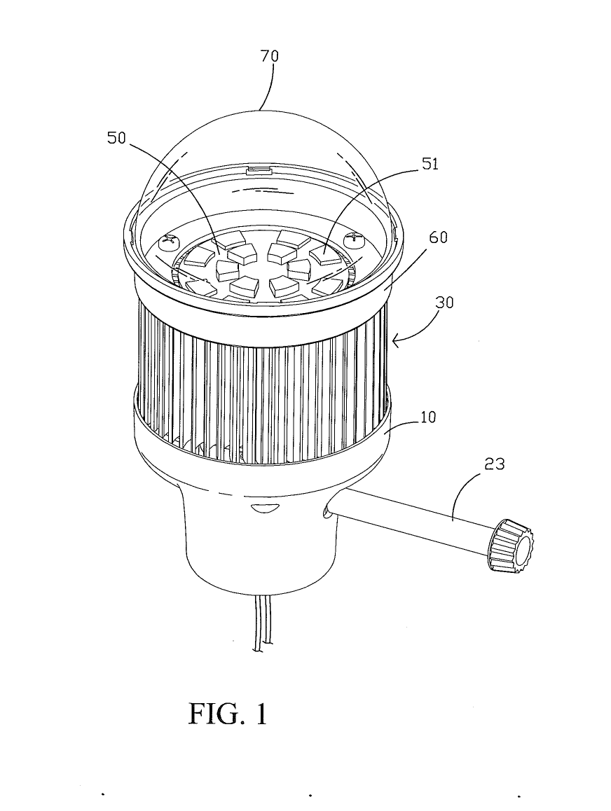

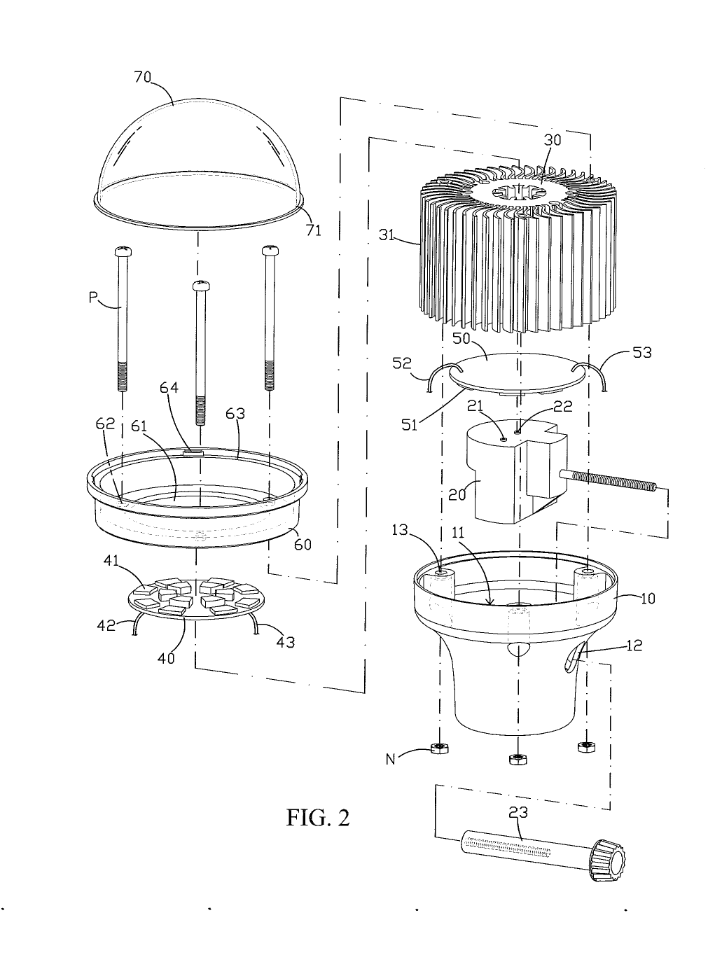

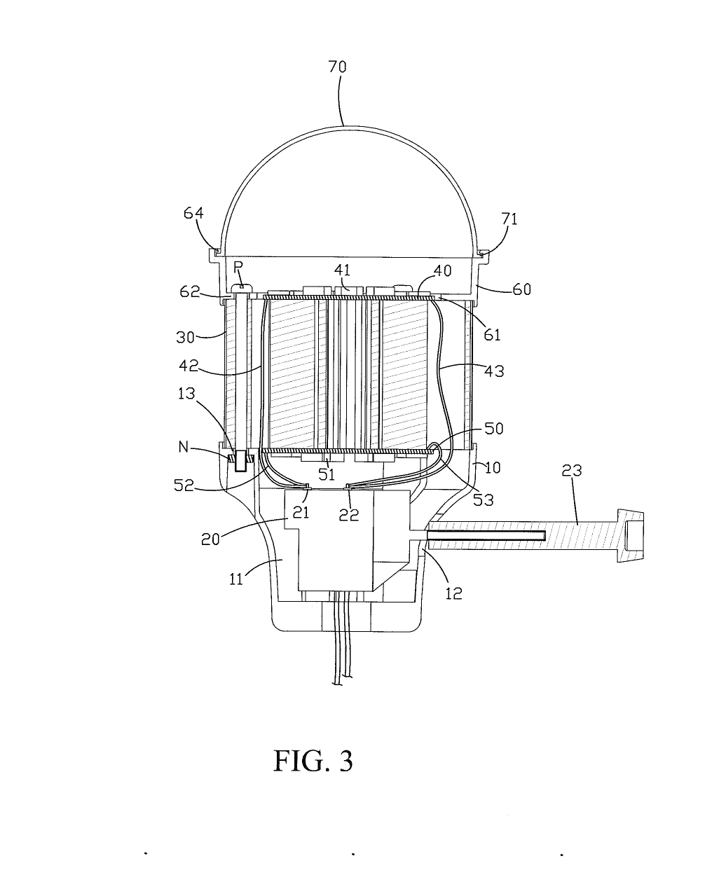

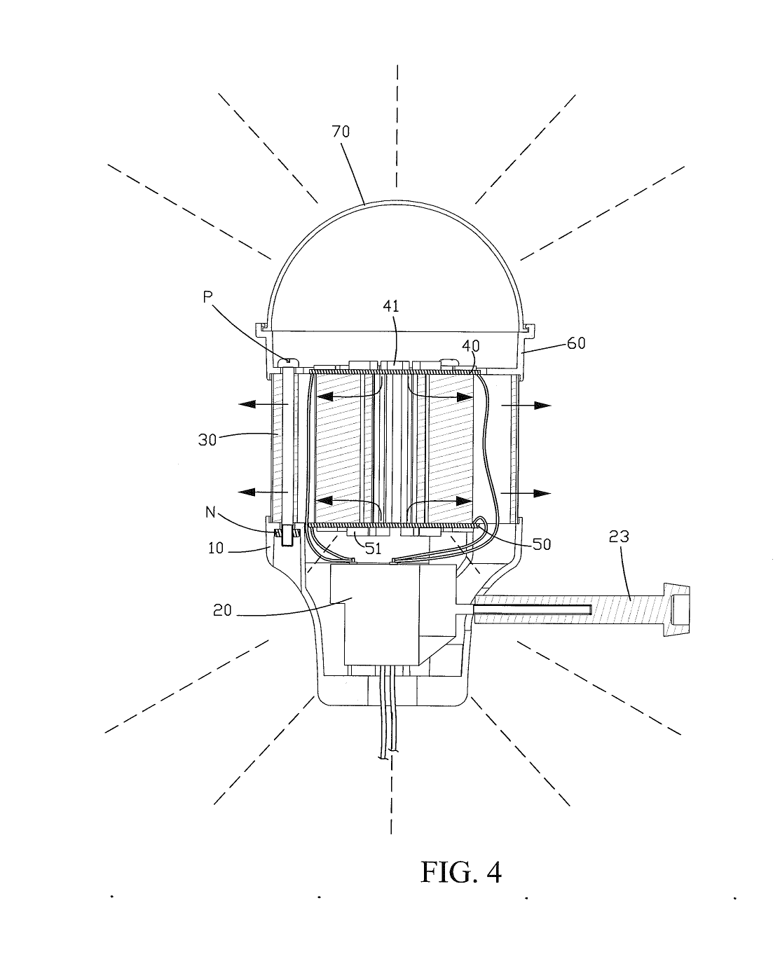

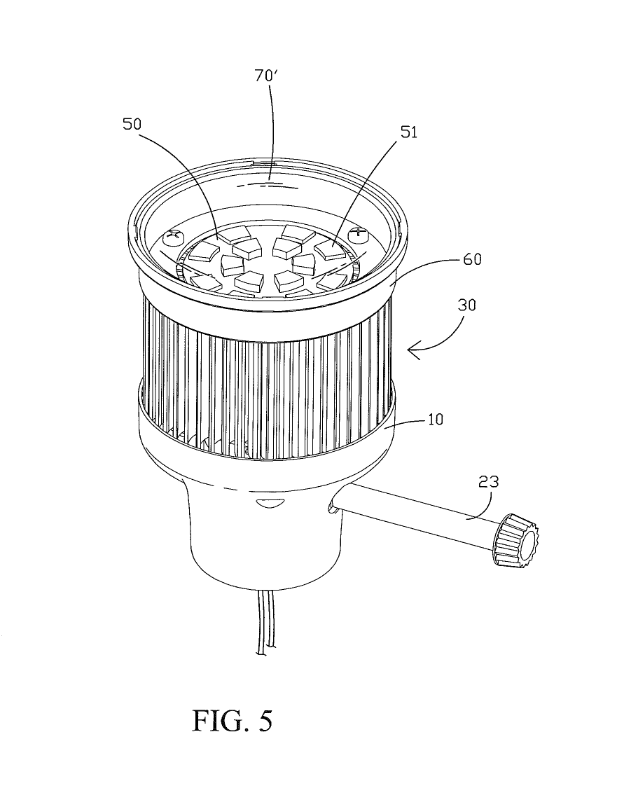

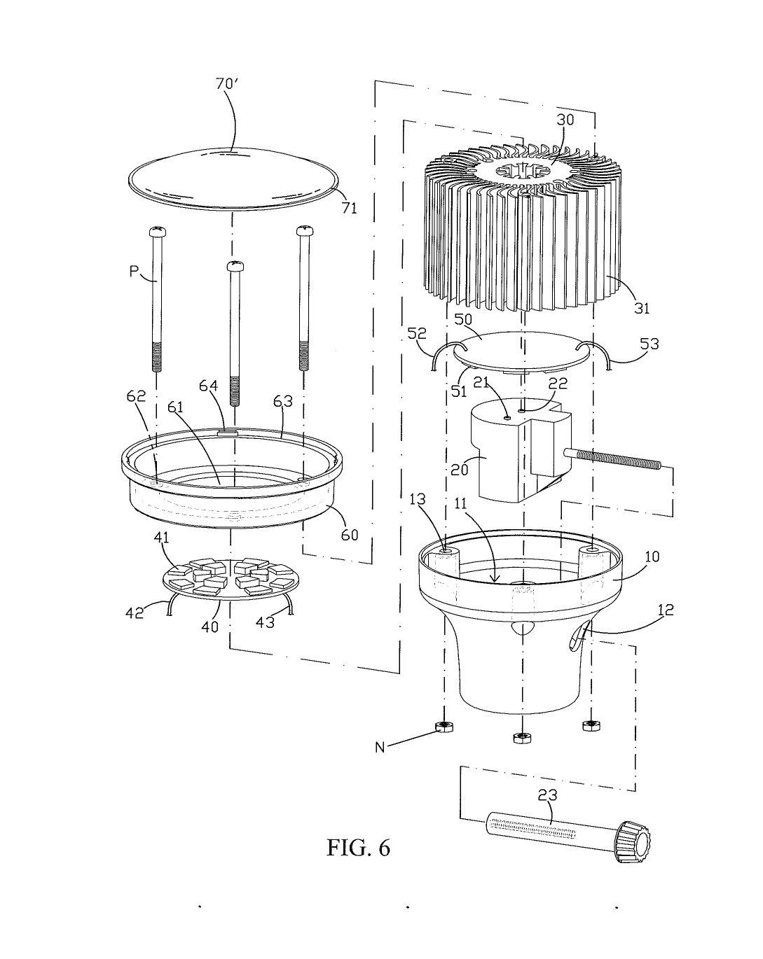

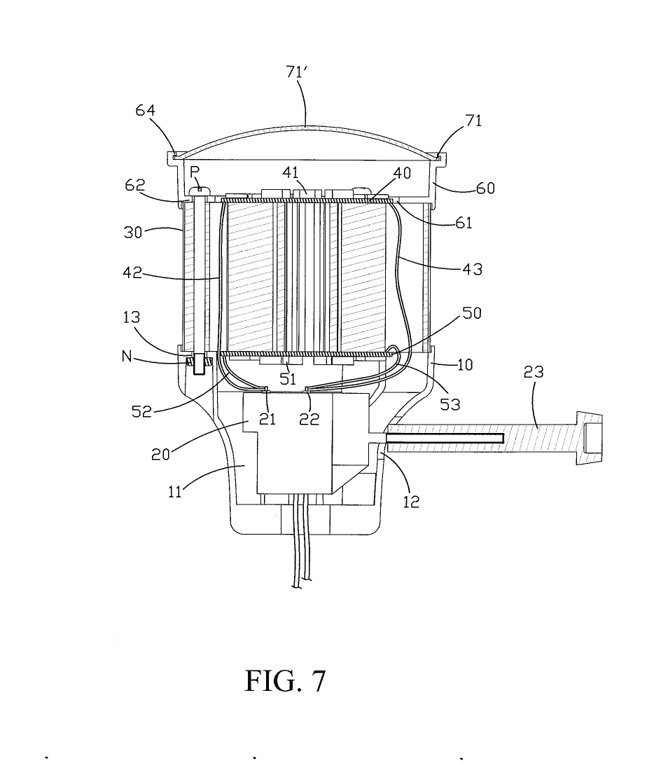

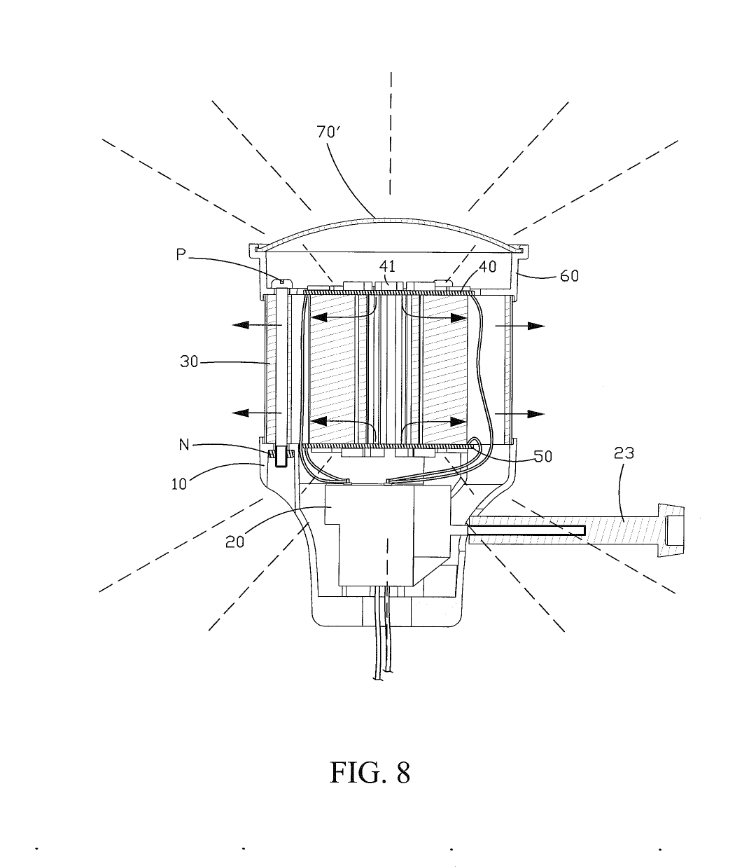

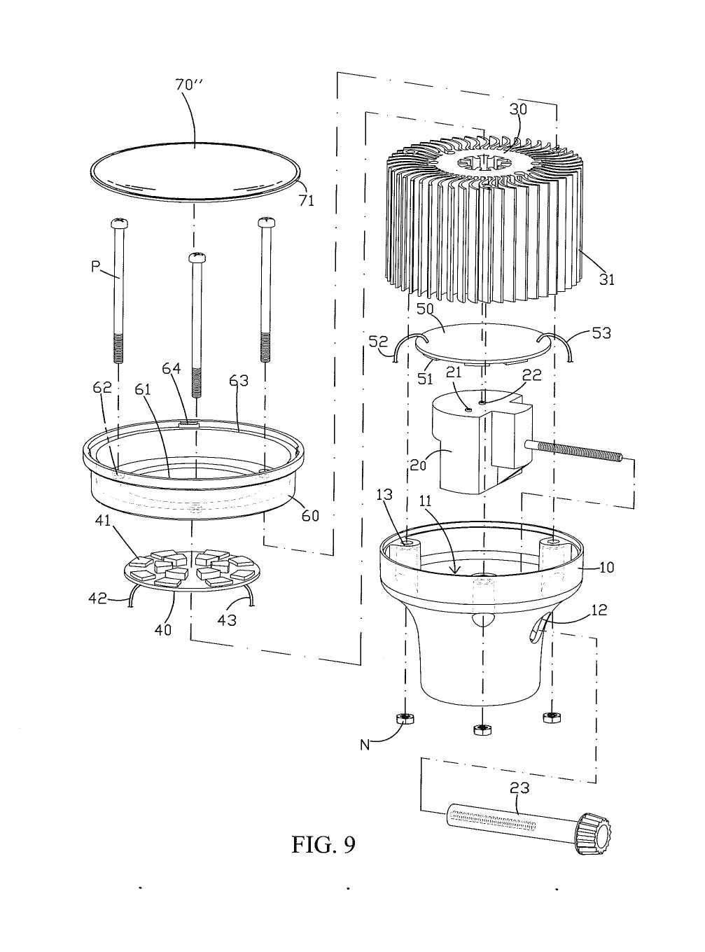

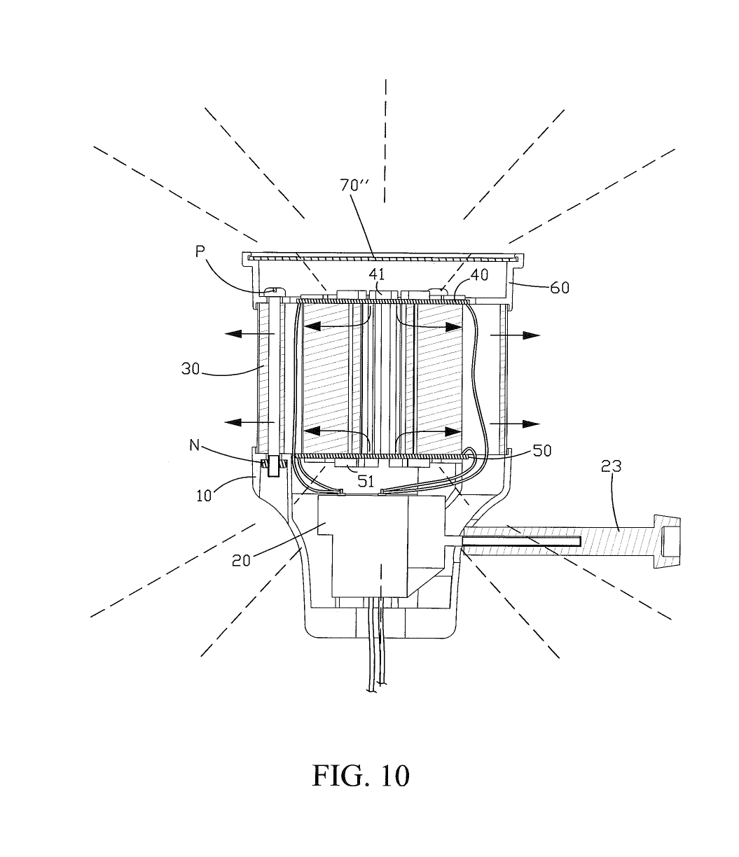

With reference to FIGS. 1 to 11, an LED bulb according to a first embodiment of the present invention comprises: a first shell 10, a power switch 20, a heat dissipating element 30, a first substrate 40, a second substrate 50, a retaining loop 60, a second shell 70, and a drive 80.

The first shell 10 includes an accommodating chamber 11 defined therein to accommodate the power switch 20, a through hole 12 formed on an outer wall thereof and communicating with the accommodating chamber 11 to insert a rotary lever 23 of the power switch 20, and three locking holes 13 equidistantly defined on a top end thereof to insert three screws P which are screwed with three nuts N, such that the retaining loop 60 is connected with the first shell 10.

The power switch 20 includes an anode contact 21 and a cathode contact 22 which are mounted on a top end thereof to electrically connect with the second substrate 50; the power switch 20 further includes the rotary lever 23 disposed on one side thereof and corresponding to the through hole 12 of the first shell 10, such that the rotary lever 23 is rotated in the through hole 12 to power on or off the LED bulb.

The heat dissipating element 30 is extrusion molded from aluminum to guide and dissipate heat efficiently and includes a plurality of heat dissipation fins 31 arranged around an outer wall thereof to increase a heat dissipation area of the heat dissipating element 30.

The first substrate 40 is mounted on a top end of the heat dissipating element 30 and includes a plurality of first LED lighting elements 41 arranged on a top end thereof, a first anode wire 42 and a first cathode wire 43 which are electrically connected with the anode contact 21 and the cathode contact 22 of the power switch 20 via two gaps of the plurality of heat dissipation fins 31.

The second substrate 50 is fixed on a bottom end of the heat dissipating element 30 and includes a plurality of second LED lighting elements 51 arranged on a bottom end thereof, a first anode wire 52 and a second cathode wire 53 which are electrically connected with the anode contact 21 and the cathode contact 22 of the power switch 20.

The retaining loop 60 includes a first orifice 61 defined on a central position thereof to expose the plurality of first LED elements 41 of the first substrate 40. The retaining loop 60 also includes three second orifices 62 equidistantly formed around a bottom end thereof to correspond to the three locking holes 13 of the first shell 10, such that the three screws P are inserted into the three locking holes 13 of the first shell 10 to screw with the three nuts N via the three second orifices 62, thus locking the first shell 10 with the retaining loop 60. The retaining loop 60 further includes a stepped rib 63 arranged around an inner wall of an top end thereof and a plurality of locking protrusions 64 extending outwardly from the stepped rib 63 to retain with the second shell 70.

The second shell is a sphere-shaped shell 70 in the first embodiment, and the second shell is a semi-arcuate shell 70′ in a second embodiment or a flat shell 70″ in a third embodiment. Each of the sphere-shaped shell 70, the semi-arcuate shell 70′, and the flat shell 70″ includes a peripheral tab 71 arranged around an inner wall of a bottom end thereof, and an outer diameter of the peripheral tab 71 is equal to an inner diameter of the stepped rib 63, wherein the peripheral tab 71 is retained with the plurality of locking protrusions 64.

The drive 80 is electrically isolated from the heat dissipating element 30, and when a radiating light fade is 5% (8760 hrs/one year), the Led bulb can be used continuously for 45,000 hours in five years, and a power factor of 100V-120V is up to 0.95 to 0.98.

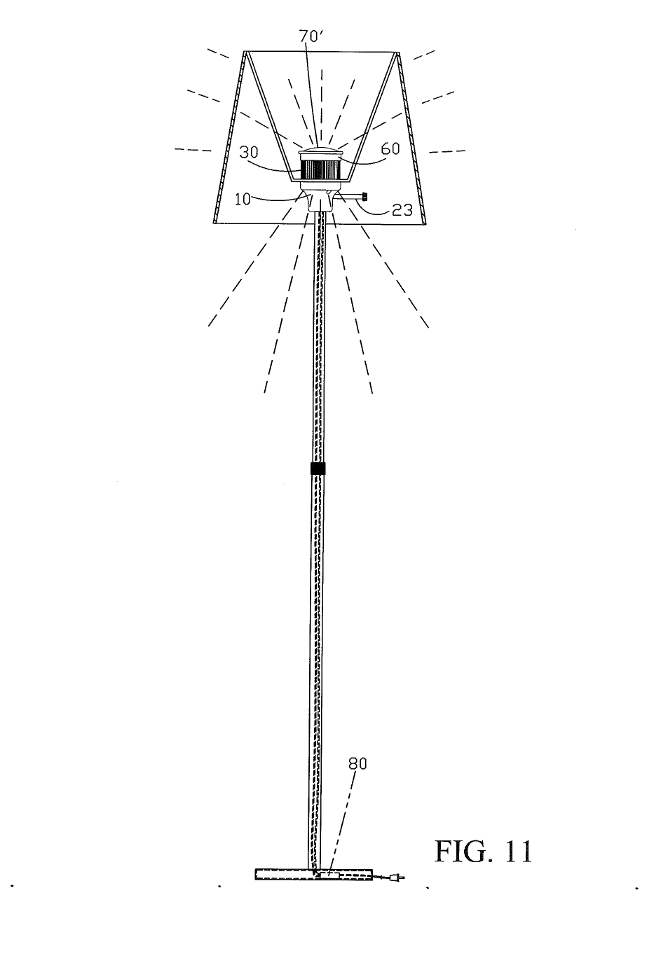

The LED bulb is applicable for a floor lamp (as shown in FIG. 11), a cloth cover lamp, a chandelier, a table lamp, a bedside lamp, a desk lamp, a tube lamp, and a down lamp.

Thereby, the LED bulb has high luminous efficiency, low power consumption, omnidirectional illumination, long service life, and rich gamut. Preferably, the LED bulb is not broken easily to save maintenance cost and is manufactured in a small size. Furthermore, the LED bulb can be applied at a low temperature.

While we have shown and described various embodiments in accordance with the present invention, it is clear to those skilled in the art that further embodiments may be made without departing from the scope of the present invention.

What is claimed is:

1. An LED bulb comprising: a substrate, at least one LED lighting element fixed on a first surface of the substrate, a heat dissipating element mounted on a second surface of the substrate, wherein the heat dissipating element is electrically isolated from a drive.

2. An LED bulb comprising: a first shell, and the first shell including an accommodating chamber defined therein to accommodate a power switch, the first shell also including a through hole formed on an outer wall thereof and communicating with the accommodating chamber to insert a rotary lever of the power switch;
the power switch including an anode contact and a cathode contact which are mounted on a top end thereof to electrically connect with a substrate, the power switch further including the rotary lever disposed on one side thereof and corresponding to the through hole of the first shell, such that the rotary lever is rotated in the through hole to power on or off a plurality of LED lighting elements on the substrate.

3. An LED bulb comprising: a first shell, a heat dissipating element, a first substrate, a retaining loop, and a second shell; wherein
the first shell includes a plurality of locking holes equidistantly defined on a top end thereof to lock the retaining loop;
the heat dissipating element includes a plurality of heat dissipation fins arranged around an outer wall thereof;
the first substrate is mounted on a top end of the heat dissipating element and includes at least one first LED lighting element arranged on a top end thereof, a first anode wire, and a first cathode wire;
the retaining loop includes a first orifice defined on a central position thereof to expose the at least one first LED element of the first substrate; the retaining loop also includes a plurality of second orifices equidistantly formed around a bottom end thereof to correspond to the plurality of locking holes of the first shell; the retaining loop further includes a stepped rib arranged around an inner wall of an top end thereof and a plurality of locking protrusions extending outwardly from the stepped rib to retain with the second shell;
the second shell includes a peripheral tab arranged around an inner wall of a bottom end thereof, and an outer diameter of the peripheral tab is equal to an inner diameter of the stepped rib, such that the peripheral tab is retained with the plurality of locking protrusions.

4. The LED bulb as claimed in claim 3, wherein the heat dissipating element further includes a second substrate fixed on a bottom end thereof, and the second substrate includes at least one second LED lighting element arranged on a bottom end thereof, a first anode wire, and a second cathode wire.

5. The LED bulb as claimed in claim 3, wherein the heat dissipating element is extrusion molded from aluminum to guide and dissipate heat.

6. The LED bulb as claimed in claim 3, wherein the second shell is any one of a sphere-shaped shell, a semi-arcuate shell, and a flat shell.
